(19) United States
(12) Patent Application Publication
(10) Pub. No.: US 2005/0162400 A1
(43) Pub. Date: Jul. 28, 2005

(54) Position encoded sensing device and a method thereof

(75) Inventors: Hsu-Ping Tseng, Hsinchu City (TW); Chen-Hsien Liao, Taipei City (TW); Ming-Fong Chiang, Sinjhuang City (TW)

Correspondence Address: ARENT FOX KINTNER PLOTKIN & KAHN, PLLC;Suite 400, 1050 Connecticut Avenue, N.W., Washington, DC, 20036-5339, US

(73) Assignee: AU OPTRONICS CORPORATION

(21) Appl. No.: 10/762,465

(22) Filed: Jan. 23, 2004

(51) Int. Cl. G09G 5/00

(52) U.S. Cl. 345/173

(57) ABSTRACT

A position encoded sensing device having a display panel, and a reflective plate having encoded information thereon. The reflective plate is disposed within the display panel. In addition, the position encoded sensing device includes a transceiver for emitting and receiving light. The transceiver transmits light onto the reflective plate, and the transceiver receives reflected light containing the encoded information from the reflective plate.

### BACKGROUND OF THE INVENTION

1. Field of the Invention

The present invention relates to a position encoded sensing device and a method of sensing a position with respect to a display device. In particular, the present invention relates to a position encoded liquid crystal display sensing device (PELCD) together with a transceiver for emitting light to the PELCD and receiving light reflected from the PELCD for sensing or determining the precise position of the transceiver with respect to the display, based on the encoded information disposed in the display device.

2. Related Art

Flat panel displays have become very popular in the electronic industry. Flat panel displays are generally provided in electronic products such as notebook computers, display monitors for personal computers, and especially handheld devices such as PDAs. Some flat panel displays are position sensible liquid crystal display (PSLCD) devices whereby the PSLCD senses the position of stylus when the stylus is in direct contact with the display panel.

For instance, FIG. 1 shows a resistive touch PSLCD 10 having a resistive touch panel layer 11 and a stylus 13. The resistive touch PSLCD 10 of FIG. 1 senses the position of the stylus 13 with respect to the display only when the stylus 13 is directly in contact or physically touches the touch panel 11 of the PSLCD 10. In other words, the resistive touch panel 11 must receive a resistive touching from the stylus 13 in order for the PSLCD 10 of FIG. 1 to sense the position of the stylus 13.

The PSLCD 10 of FIG. 1 is a complicated structure wherein the touch panel 11 is connected to an extra control circuit. Moreover, the addition of an extra touch panel layer 11 on the display increases the thickness and weight of the display.

The flat panel display can also be a LCD with an electromagnetic digitizer. FIG. 2 illustrates a flat panel display 20 having a cover and protective glass layer 21, a LCD layer 22, and an electromagnetic digitizer layer 23. The electromagnetic digitizer layer 23 contains a sensor board 25 made up wires in a grid format. The electromagnetic digitizer layer 23 is disposed at the bottom layer of the flat screen display 20. The flat screen display 20 of FIG. 2 is also pressure sensitive wherein the stylus 24 must be in direct contact with the display 20. Pressure must applied onto and be detected by the sensor board of the electromagnetic digitizer layer 23 of the display 20 in order for the display 20 to sense the position of the stylus. Once again, the display 20 as shown in FIG. 2 is a complicated structure since the sensor board 25 contains a complicated grid of wires.

FIG. 3 shows another PSLCD device 30. The PSLCD device 30 has a digital stylus 31 connected to computer (not shown) via an electrical wire. In addition, the PSLCD device 30 has a LCD 32 with a 2-D coil component 33 embedded therein. In order to sense the position of the stylus 30 on the LCD 32, the stylus 30 must be in direct physical contact with the LCD 32 wherein the stylus 30 sends signals to the computer based on the physical contact location of the stylus 30 with the 2-D coil component 33 of the display device 30. The PSLCD device 30 of FIG. 3 is a costly device since additional costs and additional steps are required to incorporate the 2-D coil component 33 within the PSLCD device 30.

FIG. 4 shows another example of a PSLCD 40 having an integrated resistive touch sensor. The PSLCD 40 includes an LCD 41 and a polarizing filter 42. Moreover, the PSLCD 40 includes a flexible conductive layer 43 disposed on the polarizing filter 42. A stylus 44 is provided to make direct physical contact with the flexible conductive layer 43 of the PSLCD 40. In order for the PSLCD 40 to sense the position of the stylus 44, the flexible conductive layer 43 must sense the resistive touch applied by the stylus 44 on the display. Since the flexible conductive layer 43 is disposed on the polarizing filter 42 of the PSLCD 40 of FIG. 4, a substantial amount of processing is made on the polarizing filter 43. As such, the transparency of the display is significantly decreased.

Given the aforementioned PSLCD devices together with their disadvantages, there is a need to have a flat screen display that can function as a position encoded liquid crystal display sensing device having a simplified module structure without requiring additional control circuitries. Moreover, there is also a need as well as a market demand for a position encoded liquid crystal display sensing device that can be thinner is size and lighter in weight.

### SUMMARY OF THE INVENTION

One example of the present invention provides a position encoded sensing device having a display panel, and a reflective plate having encoded information thereon, wherein the reflective plate is disposed within the display panel.

In another example, the present invention is directed to a method of sensing a position on a display. The method includes the steps of displaying information on a display panel, positioning a transceiver proximately to the display panel, transmitting light from a transceiver on to the display panel, receiving reflected light reflected from the display panel, the reflected light having encoded information therewith, and processing the encoded information received with the reflected light.

In yet another example, the present invention provides a system for sensing a position on a display containing a display means for displaying information on a display panel, a transmitting means for transmitting light from a transceiver on to the display panel, a first receiving means for receiving reflected light reflected from the display panel, the reflected light having encoded information therewith, and a processing means for processing the encoded information received with the reflected light.

### DESCRIPTION OF THE DRAWINGS

The accompanying drawings, which are included to provide a further understanding of the present invention and are incorporated in and constitute a part of this specification, illustrate examples of the present invention and together with the description serve to explain the principles of the present invention. In the drawings:

FIG. 1 illustrates one configuration of a resistive touch position sensing liquid crystal display;

FIG. 2 illustrates another configuration of a resistive touch position sensing liquid crystal display;

FIG. 3 illustrates another configuration of a resistive touch position sensing liquid crystal display;

FIG. 4 illustrates another configuration of a resistive touch position sensing liquid crystal display;

FIG. 5 illustrates a configuration of a position encoded liquid crystal display sensing device in accordance with a preferred embodiment of the present invention;

FIG. 6 illustrates one example of a sectional view of the PELCD in accordance with the present invention;

FIG. 7 illustrates one example of a top view of the PELCD in accordance with the present invention;

FIG. 8 illustrates another example of a sectional view of the PELCD in accordance with the present invention;

FIG. 9 illustrates another example of a top view of the PELCD in accordance with the present invention;

FIG. 10 illustrates one example of a configuration of a transceiver in accordance with the present invention; and

FIG. 11 illustrates one example of the method in which to implement the present invention.

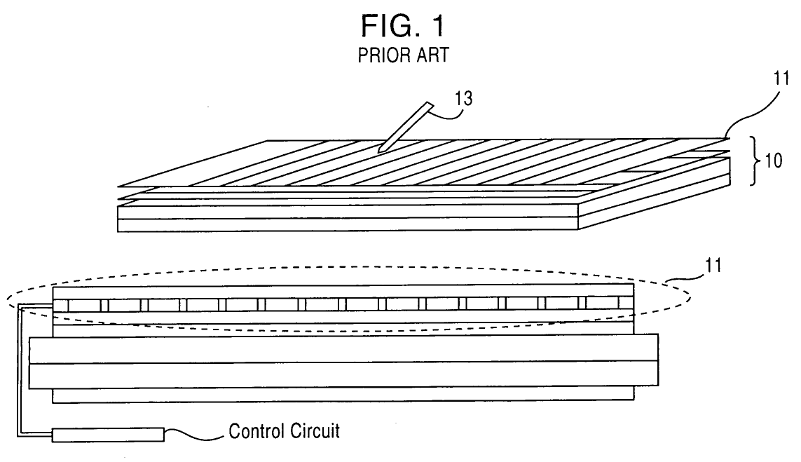

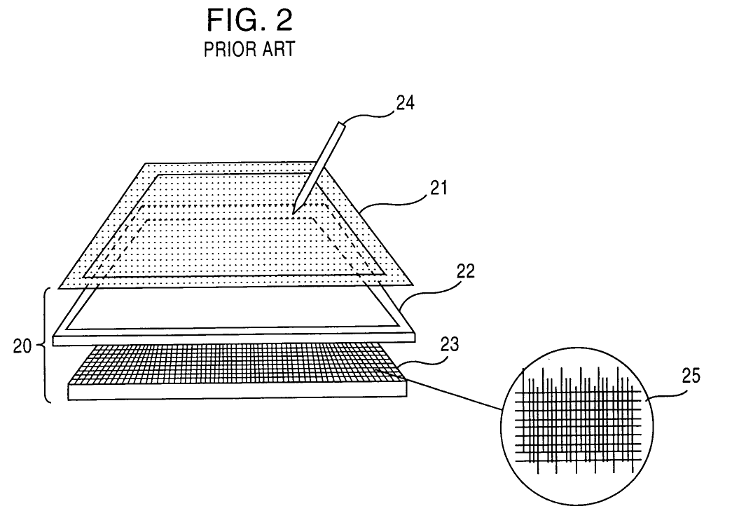

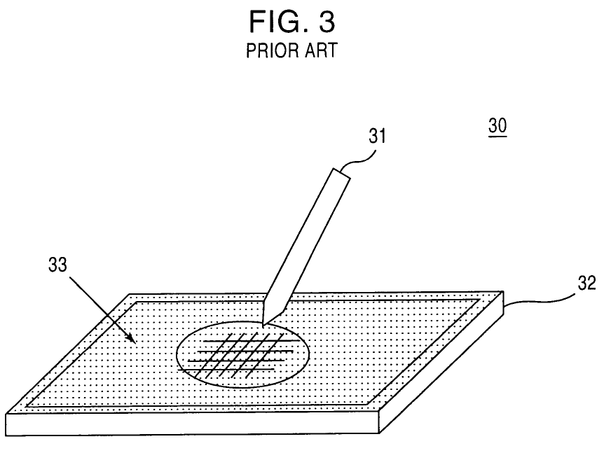

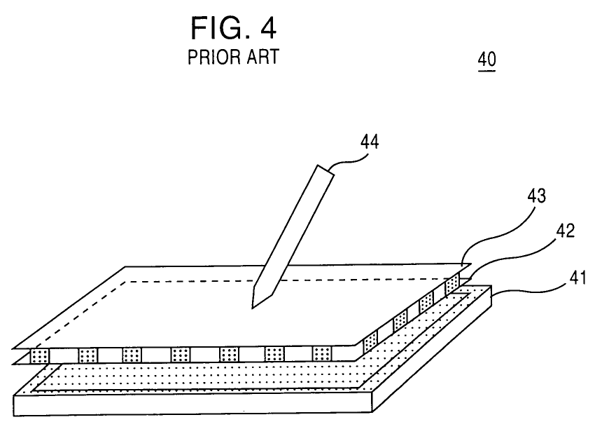

### DETAILED DESCRIPTION OF EXEMPLARY EMBODIMENTS

Reference will now be made in detail to the exemplary embodiments of the present invention, examples of which are illustrated in the accompanying drawings.

The present invention relates to a flat panel display device that employs a position encoded liquid crystal display (PELCD) with a light emitting and light receiving transceiver such as a stylus.

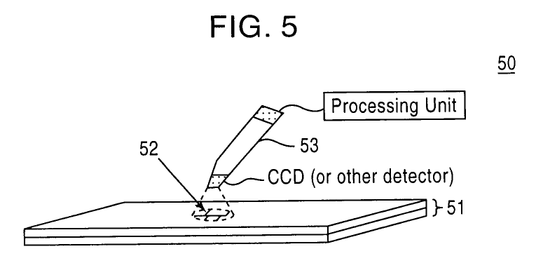

FIG. 5 illustrates one example of the PELCD device 50 of the present invention. In particular, the PELCD device 50 includes a position encoded LCD panel 51 together with a transceiver 53. Embedded within the position encoded LCD panel 51 is a high reflective layer which includes one or more high reflective plate(s). At least one of the high reflective plate includes programmable encoded information 52 such as display panel position code information. The display panel position code information can be preprogrammed or can be dynamically programmed to correspond to information or data which is displayed on the LCD 51. In addition, the display panel position code information can be embedded with the LCD 51 as a position code pattern.

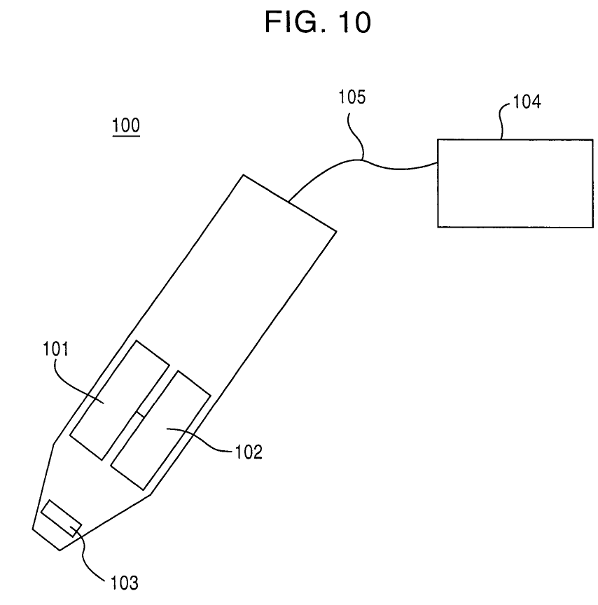

FIG. 5 also illustrates a transceiver 53 that emits light and receives/detects light 54. The transceiver 53 can be a digital stylus having a transmitter and receiver (shown in FIG. 10) of light waves, such as infra red (IR) light waves, and/or ultra violet (UV) light waves. In addition, the transceiver 53 can be connected to a processing unit (shown in FIG. 10) whereby the transceiver 53 sends information to and receives information from the processing unit.

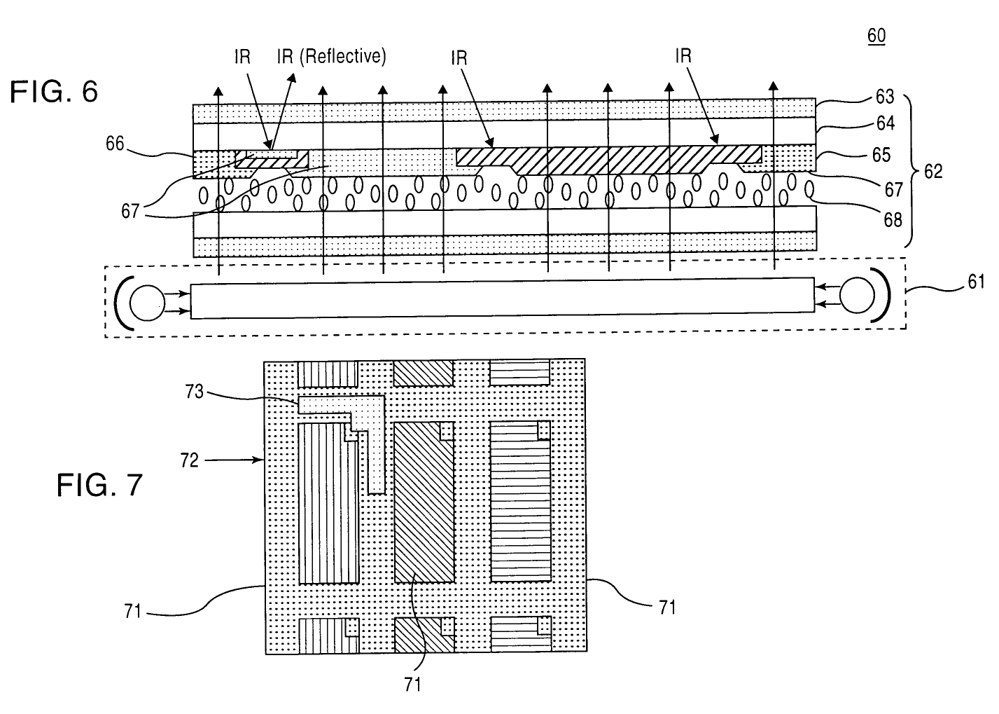

FIG. 6 shows a sectional view of a PELCD 60 in accordance with one example of the present invention.

Specifically, FIG. 6 illustrates a sectional view of the PELCD 60 having a plurality of layers. The PELCD 60 includes a back light layer 61 with a LCD panel 62. The LCD panel 62 has a polarizing plate layer 63 such as a polarizing filter. The polarizing plate layer 63 is disposed on one face of a glass substrate 64. The LCD panel 62 also includes a black matrix layer 65 and a high reflective layer 66. The high reflective layer 66 has one or more high reflective plate(s) made up of metals such as Cr, Al, Ag, or any material that can reflect light or any structure that can reflect light, and are disposed on one surface of the black matrix layer 65. The high reflective layer 66 together with the black matrix layer 65 are both disposed on the other face of the glass substrate 64. Moreover, a layer of color filters 67 is disposed between the elements of the black matrix 65 and the high reflective layer 66. The layer of color filters 67 can have at least a red color, a green color, and a blue color filter (RGB color filter). Furthermore, the LCD panel 62 includes an ITO layer 68 of electrodes disposed below the black matrix 65, the high reflective layer 66 and the layer of color filters 67.

FIG. 7 illustrates a top view of a PELCD 60 in accordance with above example of the present invention.

Specifically, FIG. 7 shows the top view of the PELCD 60 from the other face of the glass substrate 64. Referring to FIG. 7, there is one or more RGB color filter(s) 71 disposed on the other face of the glass substrate 64 of the PELCD 60. Surrounding the RGB color filter(s) is a layer black matrix 72 to shield any light coming from below, such as from the back light layer 61 of FIG. 6. Furthermore, one or more high reflective plate(s) 73 are disposed on predetermined location(s) of the black matrix 72.

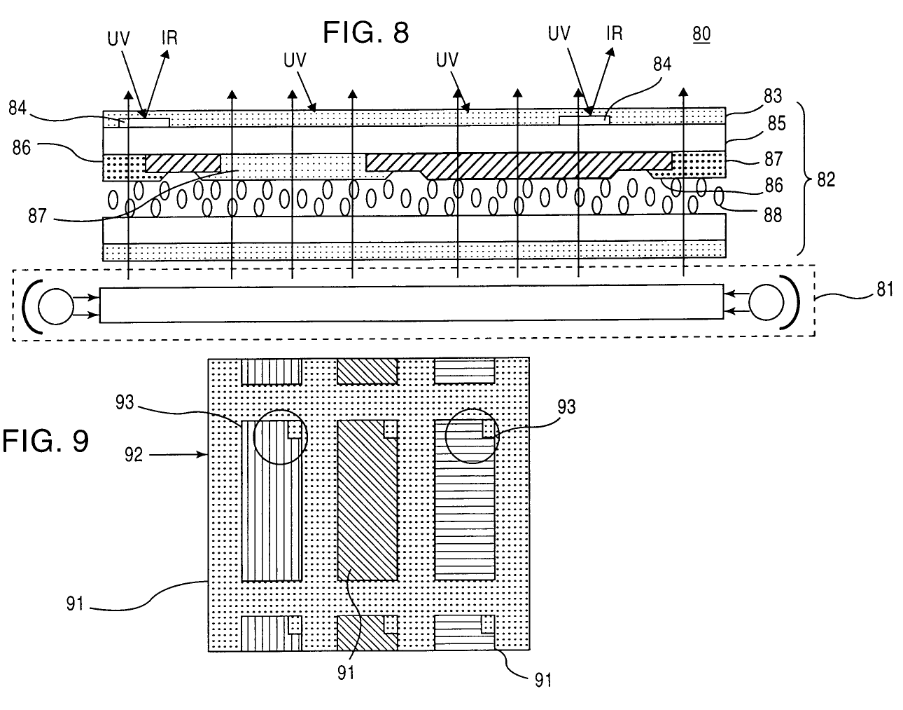

FIG. 8 shows a sectional view of a PELCD 80 in accordance with another example of the present invention.

In particular, FIG. 8 illustrates a sectional view of the PELCD 80 also having a plurality of layers. The PELCD 80 includes a back light layer 81 with a LCD panel 82. The LCD panel 82 has a polarizing plate layer 83 such as a polarizing filter. The polarizing plate 83 has a high reflective layer 84 on one face of the polarizing plate 83. The high reflective layer 84 has one or more high reflective plate(s) disposed on predetermined locations of the one face of the polarizing plate 83. Furthermore, the high reflective plates contain encoded information such as display position code information. The high reflective plate(s) can be made up of metals such as Cr, Al, Ag, or any material that can reflect light or any structure that can reflect light, to optimally reflect light out of the LCD panel 82. In addition, the polarizing plate layer 83 having one or more high reflective plate(s) disposed on the one face thereof is disposed on one face of a glass substrate 85. The LCD panel 82 of this example includes a black matrix layer 86, and is disposed on the other face of the glass substrate 85. Moreover, a layer of color filters 87 is disposed between the elements of the black matrix 86. The layer of color filters 87 has at least a red color, a green color, and a blue color filter (RGB color filter). Furthermore, the LCD panel 82 includes an ITO layer 88 of electrodes disposed below the black matrix 86 and the layer of color filters 87.

FIG. 9 illustrates a top view of a PELCD 80 in accordance with above example of the present invention.

Specifically, FIG. 9 shows the top view of the PELCD 80 from the direction of the other face of the polarizing plate layer 83. Referring to FIG. 9, there is one or more RGB color filter(s) 91 disposed on the other face of the glass substrate 85 of the PELCD 80. Surrounding the RGB color filter(s) can be a layer black matrix 92 to shield any light coming from below, such as from the back light layer 81 of FIG. 8. Furthermore, FIG. 9 shows one or more high reflective plate(s) 93 which is disposed above the glass substrate 85 and on predetermined location(s) of the polarizing plate layer 83 of FIG. 8. The high reflective plates(s) 93 includes encoded information such that when light is emitted to the high reflective plates 93, the light is optimally reflected by the high reflective plates and the encoded information is detected by a transceiver.

FIG. 10 illustrates one sectional view of a transceiver 100 such as a stylus in accordance with one example of the present invention. FIG. 10 shows a transmitter 101 that can emitting light waves. In particular, the transmitter 101 can be an infra-red (IR) light emitting diode (LED) which emits IR light waves, or an ultra-violet (UV) light emitting diode (LED) which emits UV light waves, or both. Furthermore, the transceiver 100 includes a receiver 102 for receiving and detecting reflected light such as reflected IR light and/or UV reflected light. For example, the receiver 102 can be a CCD detector, or the like. Moreover, the transceiver 100 includes a filter 103 for filtering light. The filter 103 filters light that is emitted out of the transceiver 100 and also filters light received or detected by the transceiver 100. In the example shown in FIG. 10, the transceiver 100 is connected to a processing unit 104 by an electrical wire 105. However, the transceiver 100 can be a remote wireless stylus which can communicate with the processing unit 104 remotely without any wires connecting the transceiver 100 and the processing unit 104.

Referring to FIG. 5 of the present invention, there is shown one example of PELCD panel 51 along with a transceiver 53. The PELCD panel 51 of FIG. 5 includes a high reflective layer which has one or more high reflective plate(s) disposed within the PELCD panel 51. The high reflective layer is embedded within the PELCD panel 51 by way of the examples discussed in FIGS. 6-9 above. One or more of the high reflective plate(s) includes programmable encoded information 52 such as display panel position code information. The display panel position code information can be preprogrammed or can be dynamically programmed to correspond to information or data displayed on the PELCD panel 51.

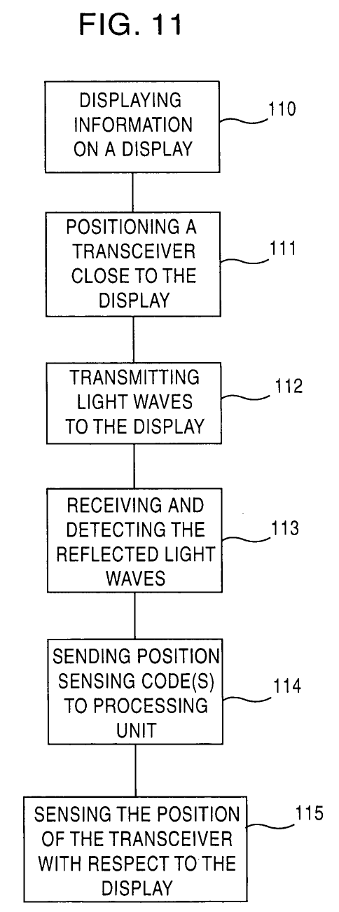

FIG. 11 illustrates one example of the method in which the present invention can function or operate in sensing the position of the stylus with respect the display panel 51.

Step 110 relates to the displaying of information such as character text, and/or images on the PELCD panel 51. Once the information is displayed on the PELCD panel 51, a user of the PELCD device 50 at step 111 positions one end of the transceiver 53 at close proximity to the PELCD panel 51. Although the transceiver 53 can be in direct physical contact with the PELCD panel 51, the PELCD device 50 of the present invention can sense or detect the exact position of the transceiver 53 with respect to the PELCD panel 51 when the transceiver 53 is not in direct physical contact with the PELCD panel 51. The transceiver 53 of the present invention can be in close proximity to the PELCD panel 51 without direct physical contact.

After positioning one end of the transceiver 53 at close proximity to the PELCD panel 51, step 112 emits light such as IR light or UV light from one end of the transceiver 53 to the surface of the PELCD panel 51. In particular, step 112 emits light from either the IR LED and/or UV LED to the high reflective layer embedded within the PELCD panel 51. For instance, the transmitter 101 at step 112 emits IR light from an IR LED, onto one or more high reflective plate(s) having display panel position sensing code information programmed thereon.

The light emitted from the transceiver 53 is reflected from the high reflective layer. Thereafter, step 113 receives and/or detects the reflected light reflected from the high reflective layer. For example, the receiver 102 such as a CCD or the like at step 113 receives and/or detects the reflected IR light reflected from at least one of the high reflective position encoded plate(s). Since the high reflective position encoded plate is provided with programmable code information such as the display panel position code information, the IR light reflected back to the transceiver 53 contains the position sensing programmable code information.

Upon receiving the reflected light having display panel position sensing code information from the high reflective layer, step 114 sends the received and detected display panel position sensing code information to a processing unit 104. The processing unit 104 processes the display panel position sensing code information received from the transceiver 53, and at step 115 the PELCD device 50 senses the exact position of the transceiver 53 with respect the PELCD panel 51 based on the programmable display panel position sensing code information encoded included with the high reflective layer.

It will be apparent those skilled in the art that various modifications and variations can be made in the position encoded liquid crystal display device of the present invention without departing from the spirit or scope of the invention. Thus, it is intended that the present invention cover the modifications and variations of this invention provided they come within the scope of the appended claims and their equivalents.

1. A position encoded sensing device comprising:
a display panel; and
a reflective plate having encoded information thereon, wherein the reflective plate is disposed within the display panel.

2. The device of claim 1, further comprising:
a light shielding layer disposed within the display panel, wherein the reflective plate is disposed on a surface of the light shielding layer.

3. The device of claim 1, further comprising:
a polarizing plate, wherein the reflective plate is disposed on a surface of the polarizing plate.

4. The device of claim 1, further comprising:
a transceiver for emitting and receiving light, wherein the transceiver transmits light onto the reflective plate, and wherein the transceiver receives reflected light containing the encoded information from the reflective plate.

5. The device of claim 4, wherein the transceiver comprises a transmitter for emitting light, a receiver for receiving or detecting reflected light, and a filter for filtering light.

6. The device of claim 1, wherein the encoded information comprises a sensing programmable code.

7. A method of sensing a position on a display, said method comprising the steps of:
displaying information on a display panel;
positioning a transceiver proximately to the display panel;
transmitting light from a transceiver on to the display panel;
receiving reflected light reflected from the display panel, the reflected light having encoded information therewith; and
processing the encoded information received with the reflected light.

8. The method of claim 7, wherein the step of transmitting light comprises the step of:
transmitting light from the transceiver on to at least one reflective plate disposed within the display panel, the at least one reflective plate having encoded information programmed thereon.

9. The method of claim 7, wherein the step of receiving comprises the step of:
receiving reflected light having at least position sensing code information therewith.

10. The method of claim 7, wherein the step of processing comprises the steps of:
receiving the encoded information received with the reflected light;
determining a position of the transceiver with respect to the panel display based on the received encoded information.

11. A system for sensing a position on a display comprising:
a display means for displaying information on a display panel;
a transmitting means for transmitting light from a transceiver on to the display panel;
a first receiving means for receiving reflected light reflected from the display panel, the reflected light having encoded information therewith; and
a processing means for processing the encoded information received with the reflected light.

12. The system of claim 11, wherein the transmitting means transmits light on to at least one reflective plate disposed within the display panel, the at least one reflective plate having encoded information programmed thereon.

13. The system of claim 11, wherein the first receiving means receives reflected light having at least position sensing code information therewith.

14. The system of claim 11, wherein the processing means comprises:
a second receiving means for receiving the encoded information received with the reflected light;
a determining means for determining a position of the transceiver with respect to the panel display based on the received encoded information.
